(19) United States
(12) Patent Application Publication
(10) Pub. No.: US 2022/0346171 A1
(43) Pub. Date: Oct. 27, 2022

(54) ENHANCED MULTI-LINK OPERATION BASED ON CAPABILITY AND OPERATION MODE

(71) Applicant: MediaTek Singapore Pte. Ltd., Singapore (SG)

(72) Inventors: Kai Ying Lu, San Jose, CA (US); Hung-Tao Hsieh, Hsinchu City (TW); Cheng-Yi Chang, Hsinchu City (TW); James Chih-Shi Yee, San Jose, CA (US); Yongho Seok, San Jose, CA (US)

(21) Appl. No.: 17/724,291

(22) Filed: Apr. 19, 2022

Related U.S. Application Data
(60) Provisional application No. 63/177,466, filed on Apr. 21, 2021.

(51) Int. Cl. H04W 76/16; H04B 7/06; H04B 7/0408; H04L 1/00

(52) U.S. Cl. CPC H04W 76/16; H04B 7/0617; H04B 7/0408; H04L 1/0003; H04W 88/06

(57) ABSTRACT

Embodiments of the present invention provide improved multi-link operation over EML links. A non-AP MLD indicating support of EMLMR operation announces it's the number of spatial streams supported for receiving or transmitting after receiving the initial frame exchange during enhanced multi-link multi-radio (EMLMR) operation (MLD level capabilities). MLD level capabilities for operating over the EMLSR links is defined so that the EMLMR capable devices can improve/optimize their performance based on their computing capabilities and RF design.

### CROSS-REFERENCE TO RELATED APPLICATIONS

This application claims the benefit of and priority to provisional patent application Ser. No. 63/177,466, Attorney Docket Number MUSI-21-0050PUS, with filing date Apr. 21, 2021, by Kai Ying Lu, et al., which is hereby incorporated by reference in its entirety.

### FIELD

Embodiments of the present invention generally relate to the field of wireless communications. More specifically, embodiments of the present invention relate to systems and methods for enhanced multi-link operation in a wireless network.

### BACKGROUND

Modern electronic devices typically send and receive data with other electronic devices wirelessly using Wi-Fi, and many of these electronic devices are “dual band” devices that include at least two wireless transceivers capable of operating in different frequency bands, e.g., 2.4 GHz, 5 GHz, and 6 GHz. In most cases, a wireless device will communicate over only a single band at a time. For example, older and low-power devices, e.g., battery powered devices, often operate on the 2.4 GHz band. Newer devices and devices that require greater bandwidth often operate on the 5 GHz band. The availability of the 6 GHz band is a recent advancement and can provide higher performance, lower latency, and faster data rates.

The use of a single band may not satisfy the bandwidth or latency needs of certain devices. Therefore, some developing approaches to wireless communication increase communication bandwidth by operating on multiple bands concurrently (technically called link aggregation or multi-link operation). Advantageously, multi-link operations can provide higher network throughput and improved network flexibility compared to traditional techniques for wireless communication.

A non-AP (STA) MLD may operate in the enhanced multi-link multi-radio (EMLMR) mode on a specified set of the enabled links for improved performance. The set of the enabled links in which the EMLMR mode is applied can be referred to as EMLMR links. When the non-AP MLD associates with an AP MLD, the EMLMR mode for the non-AP MLD is enabled immediately after the association. The non-AP MLD can receive PPDUs with the number of spatial streams up to the value as indicated in the EMLMR Rx NSS subfield of the element on the link for which the initial frame exchange was made. The non-AP MLD can also transmit PPDUs with the number of space-time streams up to the value as indicated in the EMLMR Tx NSS subfield of the element on the link for which the initial frame exchange was made.

### SUMMARY

Accordingly, embodiments of the present invention provide improved multi-link operation over EMLMR links. A non-AP MLD indicating support for EMLMR operation announces the number of spatial streams supported for receiving after receiving the initial frame exchange during the EMLMR operation (e.g., MLD level capabilities). The MLD level capabilities for operating over the EMLMR links are defined so that the EMLMR capable devices can improve/optimize their performance based on their computing capabilities and RF design. For example, if one link with two spatial streams corresponding to per-link spatial stream capabilities of the EMLMR links has bandwidth of 320 MHz in a 6 GHz band, and another EMLMR link with two spatial streams corresponding to per-link spatial stream capabilities has bandwidth of 160 MHz in a 5 GHz band, two spatial streams may be used for bandwidth 320 MHz after the initial frame exchange on an EMLMR link in the 6 GHz band subject to the device processing/computing capabilities, and four spatial streams may be used for bandwidth 160 MHz (5 GHz) by combining two spatial streams of each EMLMR link in the 5 GHz band and 6 GHz band after the initial frame exchange in the 5 GHz band based on the device processing/computing capabilities.

According to one embodiment, a method of wireless data reception by a non-access point (non-AP) multi-link device (MLD) is disclosed. The method includes associating with an access point (AP) MLD, enabling an enhanced multi-link (EML) operation mode on a plurality of EML links, transmitting a frame to the AP MLD indicating a maximum number of supported spatial streams (NSS) corresponding to a specific modulation and coding scheme (MCS) in a physical layer protocol data unit (PPDU) using a specific supported bandwidth for receiving the PPDU using the EML operation, and receiving the PPDU from the AP MLD over a first EML link of the plurality of EML links using a number of spatial streams that is no greater than the maximum number of supported spatial streams indicated in the frame for a combination of MCS and NSS over the first EML link using the specific supported bandwidth in the EML operation mode.

According to some embodiments, the maximum number of supported spatial streams using the EML operation mode is equal to or less than a total number of supported spatial streams corresponding to per-link spatial stream capabilities over the plurality of the EML links.

According to some embodiments, the method includes performing an initial frame exchange with the AP MLD using per-link spatial stream capabilities over the first EML link of the plurality of EML links, and the receiving of the PPDU from the AP MLD over the first EML link is performed responsive to the performing an initial frame exchange.

According to some embodiments, the frame includes a modulation and coding scheme (MCS) value and a maximum number of spatial streams (NSS) field value including a combination of maximum numbers of supported spatial streams for different MCSs supported by the bandwidths.

According to some embodiments, the MCS and NSS includes a plurality of Rx EHT-MCS map subfields that map a maximum number of spatial streams to an MCS supported for a specific bandwidth corresponding to at least one of the EML links.

According to some embodiments, the plurality of EML links includes a second EML link and, and the first and second EML links use different plurality of Rx EHT-MCS map subfields for different bandwidths.

According to some embodiments, the non-AP MLD includes a plurality of radios operating over different frequencies for performing enhanced multi-link multi-radio (EMLMR) operations.

According to another embodiment, a method of transmitting wireless data by a non-access point (non-AP) multi-link device (MLD) is disclosed. The method includes associating with an access point (AP) MLD, enabling an enhanced multi-link (EML) mode on a plurality of EML links, transmitting a frame to the AP MLD indicating a maximum number of supported spatial streams (NSS) corresponding to a specific modulation and coding schemes (MCS) value in a physical layer protocol data unit (PPDU) with a specific supported bandwidth for transmitting the PPDU using the EML operation, and transmitting the physical layer protocol data unit (PPDU) to the AP MLD over a first EML link of the plurality of EML links with the number of spatial streams up to the value indicated in the frame as being supported by a combination of MCS and NSS in a bandwidth of the first EML link using the EML operation.

According to some embodiments, the maximum number of supported spatial streams using the EML operation mode is equal to or less than a total number of supported spatial streams corresponding to per-link capabilities over the plurality of the EML links.

According to some embodiments, the method includes performing an initial frame exchange with the AP MLD over the first EML link of the plurality of EML links using an MCS and an NSS indicated in the frame as being supported by a bandwidth of the first EML link using the EML operation, and the transmitting of the PPDU to the AP MLD over the first EML link is performed responsive to the performing an initial frame exchange.

According to some embodiments, the frame includes a modulation and coding scheme (MCS) and a maximum number of spatial streams (NSS) including a mapping of maximum numbers of supported spatial streams for different MCSs supported by different bandwidths.

According to some embodiments, the MCS and NSS includes a plurality of Tx EHT-MCS map subfields that map a maximum number of spatial streams to an MCS supported for a specific bandwidth corresponding to at least one of the EML links.

According to some embodiments, the plurality of EML links includes a second EML link, and the first and second EML links use different Tx EHT-MCS map subfields for different bandwidths.

According to some embodiments, the non-AP MLD include a plurality of radios operating over different frequencies for performing enhanced multi-link multi-radio (EMLMR) operations.

According to a different embodiment, an apparatus for communicating wirelessly over a plurality of enhanced multi-link (EML) links is disclosed. The apparatus includes a processor, a memory coupled to the processor and for storing data, and a plurality of radios operable to perform EML operations over the plurality of EML links. The processor is operable to associate with an access point (AP) MLD, enable an enhanced multi-link (EML) mode on a plurality of EML links, transmit a frame to the AP MLD indicating a maximum numbers of supported spatial streams (NSS) corresponding to a specific modulation and coding schemes (MCS) value in a physical layer protocol data unit (PPDU) with a specific supported bandwidth using the EML operations, receive a first PPDU from the AP MLD over a first EML link of the plurality of EML links with the number of spatial streams up to the value indicated in the frame as being supported by a combination of MCS and NSS in a bandwidth of the first EML link, and transmit a second PPDU to the AP MLD over a second EML link of the plurality of EML links with the number of spatial streams up to the value indicated in the frame as being supported by a combination of MCS and NSS in a bandwidth of the second EML link.

According to some embodiments, the processor is further operable to perform an initial frame exchange with the AP MLD using per-link spatial stream capabilities over the first EML link of the plurality of EML links, and the receiving the first PPDU from the AP MLD over the first EML link is performed responsive to the initial frame exchange.

According to some embodiments, the processor is further operable to transmit an initial frame to the AP MLD over the second EML link of the plurality of EML links using an MCS and an NSS indicated in the frame as being supported by a bandwidth of the second EML link using the EML operation, and the transmitting of the PPDU to the AP MLD over the second EML link is performed responsive to the initial frame exchange.

According to some embodiments, the transmit a frame to the AP MLD indicating maximum numbers of supported spatial streams (NSS) corresponding to a specific modulation and coding schemes (MCS) value in a PPDU with a specific supported bandwidth using EML operations over a plurality of supported bandwidths includes transmitting an extremely high throughput (EHT)-modulation and coding scheme (MCS) and maximum number of spatial streams (NSS) set field including a mapping of a maximum number of supported spatial streams for different MCSs supported by the bandwidths.

According to some embodiments, the EHT-MCS and NSS set field includes a plurality of Rx EHT-MCS map subfields and Tx EHT-MCS map subfields that map a maximum number of spatial streams to an MCS that are supported for a specific bandwidth corresponding to at least one of the EML links.

According to some embodiments, the frame further indicates at least one of: a maximum number of sounding dimensions for performing a sounding procedure over a specific EML link using the EML operation, a beamformee spatial stream indicating the maximum number of spatial streams that can be received in an extremely high throughput (EHT) sounding null data packet (NDP) over a specific EML link using the EML operation, and a maximum dimension of compressed beamforming over a specific EML link using the EML operation.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary EHT-MCS and NSS field for performing wireless transmissions using an EMLMR operating mode according to embodiments of the present invention.

FIG. 2 is a block diagram of exemplary Rx/Tx EHT-MCS Map subfields of an exemplary EHT-MCS and NSS field for performing wireless transmissions using an EMLMR operating mode according to embodiments of the present invention.

FIG. 3 is a flowchart depicting steps of an exemplary computer-implemented process for automatically indicating MLD capabilities and performing EMLMR operations in a wireless network according to embodiments of the present invention.

FIG. 4 is a block diagram depicting an exemplary computer system platform upon which embodiments of the present invention may be implemented.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

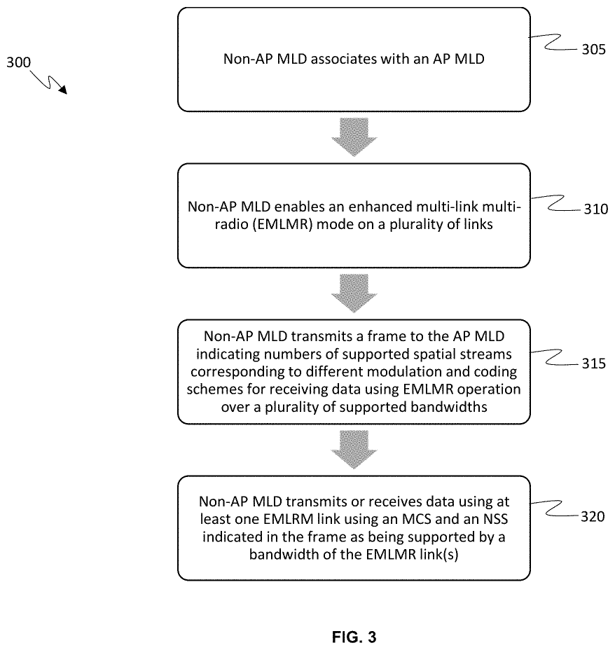

Portions of the detailed description that follow are presented and discussed in terms of a method. Although steps and sequencing thereof are disclosed in a figure herein (e.g., FIG. 3) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “configuring,” “coordinating,” “storing,” “transmitting,” “authenticating,” “identifying,” “requesting,” “reporting,” “determining,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### Enhanced Multi-Link Multi-Radio Capability and Operation Mode Scheme

Embodiments of the present invention provide improved multi-link operation over EMLMR links. A non-AP MLD indicating support of EMLMR operation announces the combination of number of spatial streams and modulation and coding schemes (MCS) value supported for receiving or transmitting on one of the EMLMR link of a plurality of EMLMR links during EMLMR operation (e.g., MLD level capabilities). MLD level capabilities for the EMLMR operation over the EMLMR links are defined so that the EMLMR capable devices can improve/optimize their performance based on their computing capabilities and RF design.

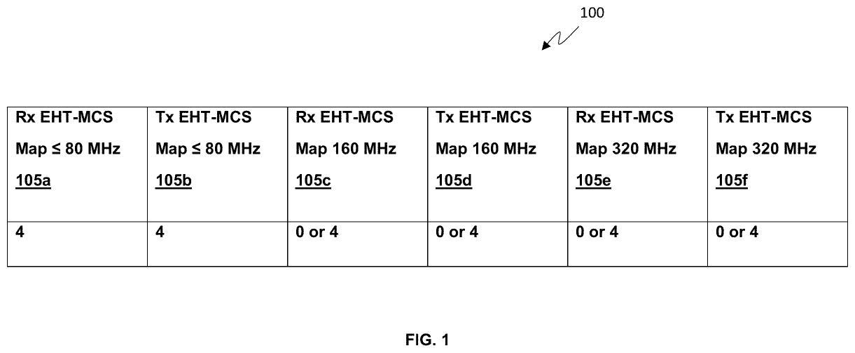

FIG. 1 depicts an exemplary “Supported EHT capabilities EHT-MCS and NSS Set” field 100 in an extremely high throughput (EHT) capabilities element indicating spatial stream capabilities corresponding to each MCS value for receiving or transmitting in the EMLMR operating mode according to embodiments invention. An STA indicating support for EMLMR operating mode may use the “Supported the EHT capabilities EHT-MCS And NSS Set” field in an EML operation mode notification frame to indicate the combinations of EHT-MCSs and spatial streams that the STA supports for reception and the combinations that it supports for transmission during EMLMR operation mode, which are MLD level EML capabilities. The supported EHT-MCS and NSS Set field in EHT capabilities element corresponding per-link capabilities (e.g., when EMLMR operation mode is disabled) indicates the combinations of EHT-MCSs and spatial streams that an STA supports for reception of the initial frame exchange from the AP MLD, which are link level capabilities.

EHT-MCS maps 105a-f depicted in FIG. 1 corresponds to multiple Rx EHT-MCS map and Tx EHT-MCS map subfields (e.g., each subfield has 4 bytes in length), and multiple Rx EHT-MCS map and Tx EHT-MCS map subfields for bandwidths 160 MHz and 320 MHz can optionally be included. In the example of FIG. 1, Rx EHT-MCS map field 105a indicates the combinations of maximum number of spatial streams and MCS values of the STA for receiving in EMLMR mode using a bandwidth equal to 80 MHz or less. The Tx EHT-MCS map field 105b indicates the combinations of maximum number of spatial streams and MCS values of the STA for transmitting in EMLMR mode using a bandwidth equal to 80 MHz or less. The Rx EHT-MCS map 105c indicates the combinations of maximum number of spatial streams and MCS values of the STA for receiving in EMLMR mode using a bandwidth equal to 160 MHz. The Tx EHT-MCS map field 105d indicates the combinations of maximum number of spatial streams and MCS values of the STA for transmitting in EMLMR mode using a bandwidth equal to 160 MHz. The Rx EHT-MCS map field 105e indicates the combinations of maximum number of spatial streams and MCS values of the STA for receiving in EMLMR mode using a bandwidth equal to 320 MHz. The Tx EHT-MCS map field 105f indicates the combinations of maximum number of spatial streams and MCS values of the STA for transmitting in EMLMR mode using a bandwidth equal to 320 MHz.

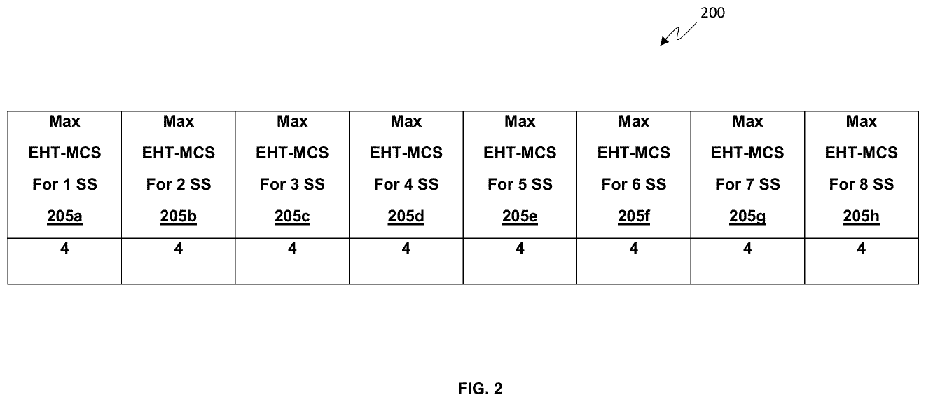

FIG. 2 depicts an exemplary EHT-MCS Map subfields of a Tx/Rx EHT-MCS map 200 according to embodiments of the present invention. MAX EHT-MCS Map for n spatial stream (SS) subfields 205a-h (e.g., each subfield has 4 bits in length) indicate the combination of maximum number (n) of spatial stream (SS) and each supported EHT-MCS (set) value for the different bandwidths supported by an MLD device in EMLMR operating mode. In the example depicted in FIG. 2, the value of Max EHT-MCS for n=8 SS subfields is encoded as shown in Table I below.

TABLE I

| Value | Capability | Spatial Streams |
|---|---|---|
| 0 | support for EHT-MCS 0-7 | n spatial streams |
| 1 | support for EHT-MCS 0-9 | n spatial streams |
| 2 | support for EHT-MCS | n spatial streams |
| | 0-11 | |
| 3 | support for EHT-MCS | n spatial streams |
| | 0-13 | |
| 4 | n spatial streams is not | |
| | supported for EHT PPDUs | |
| | when EMLMR mode is | |
| | disabled | |
| 5 | support for EHT-MCS 0-7 | n spatial streams after the |
| | | initial frame exchange in |
| | | EMLMR operating mode |
| 6 | support for EHT-MCS 0-9 | n spatial streams after the |
| | | initial frame exchange in |
| | | EMLMR operating mode |
| 7 | support for EHT-MCS | n spatial streams after the |
| | 0-11 | initial frame exchange in |
| | | EMLMR operating mode |
| 8 | support for EHT-MCS | n spatial streams after the |
| | 0-13 | initial frame exchange in |
| | | EMLMR operating mode |

Based on the capabilities depicted in FIGS. 1 and 2, an MLD device supporting EMLMR mode can announce EML capabilities for transmitting and receiving data over EMLMR links using EMLMR operation mode. For example, for a supported bandwidth included in the EMLMR supported EHT-MCS And NSS set field 100 of FIG. 1, the combination of supported MCS and maximum numbers of spatial streams corresponding to the bandwidth can be determined using EHT-MCS map subfields 205a-h depicted in FIG. 2. In the example of FIG. 2, EHT-MCS map 205a indicates the combination of MCS set value and maximum 1 SS, EHT-MCS map 205b indicates the combination of MCS set value and maximum 2 SS, EHT-MCS map 205c indicates the combination of MCS set value and maximum 3 SS, EHT-MCS map 205d indicates the combination of MCS set value and maximum 4 SS, EHT-MCS map 205e indicates the combination of MCS set value and maximum 5 SS, EHT-MCS map 205f indicates the combination of MCS set value and maximum 6 SS, EHT-MCS map 205g indicates the combination of MCS set value and maximum 7 SS, and EHT-MCS map 205h indicates the combination of MCS set value and maximum 8 SS. EMLMR transmission and reception for an EMLMR link can be performed using the combination of supported MCS and maximum number of spatial streams for a given bandwidth.

When a non-AP MLD operating in EMLMR mode receives an initial frame from the AP MLD using its per-link spatial stream capabilities on one of the EMLMR links, after initial frame exchange on the EMLMR link, the non-AP MLD will support the following capabilities until the end of the frame exchange sequence initiated by the initial frame exchange:
1. The capability to receive PPDUs with the number of spatial streams (NSS) up to the value indicated in the Max EHT-MCS For n SS of Rx EHT-MCS Map subfield in the supported EHT-MCS and NSS Set field corresponding to a given bandwidth and EHT-MCS on the link for which the initial frame exchange is made. The maximum receive NSS for a given EHT-MCS is equal to the maximum value of number of spatial streams for which the Max EHT-MCS for n SS has a value that indicates support for that EHT-MCS. For example, the non-AP MLD indicates support for Max EHT-MCS 9 For 4 SS and Max EHT-MCS 11 For 2 SS. When the given EHT-MCS is 8, then the maximum receive NSS for the given EHT-MCS 8 is 4.
2. The capability to transmit PPDUs with the number of spatial streams up to the value as indicated in the Max EHT-MCS for n SS of Tx EHT-MCS Map subfield in the supported EHT-MCS and NSS set subfield corresponding to a given bandwidth and EHT-MCS for the EMLMR operating mode at a time on the link for which the initial frame exchange is made. The maximum transmit NSS for a given EHT-MCS is equal to the maximum value of the number of spatial streams for which the Max EHT-MCS for n SS has a value that indicates support for that EHT-MCS. For example, the non-AP MLD indicates support for Max EHT-MCS 9 for 4 SS and Max EHT-MCS 11 For 2 SS. When the given EHT-MCS is 8, then the maximum receive NSS for the given EHT-MCS 8 is 4.

A non-AP MLD that indicates support for EMLMR operation announces its EMLMR capabilities corresponding to one or more specific parameters, such as bandwidth, MCS, etc. For example, the EMLMR capabilities can include the capabilities shown in Table II below.

TABLE II

The maximum number of spatial streams for receiving or transmitting data after the
initial frame exchange while operating in EMLMR mode. The maximum number of
spatial streams can correspond to the bandwidth and the modulation and coding
scheme (MCS) of the link.
The maximum number of sounding dimensions indicating the beamformer’s capability
regarding the maximum value of the TXVECTOR parameter NUM_STS for an EHT
sounding null data packet (NDP) after the initial frame exchange in the EMLMR mode,
which can correspond to bandwidth.
The beamformee spatial streams indicating the maximum number of spatial streams
that the STA can receive in an EHT sounding NDP or the maximum total number of
spatial streams over all the users that can be sent in a downlink (DL) multi-user
multiple input multiple output (MU-MIMO) transmission on a resource unit
(RU)/mobile resource unit (MRU) after the initial frame exchange in the EMLMR
operating mode, which may correspond to the bandwidth of the link.
Max Nc indicating the maximum supported Nc for an EHT compressed
beamforming/channel quality indication (CQI) report after the initial frame exchange
in the EMLMR operating mode, which may correspond to the bandwidth of the link.

FIG. 3 is a flowchart of steps of an exemplary computer-implemented process 300 for automatically indicating EML capabilities of an MLD device to perform EMLMR operations according to embodiments of the present invention.

At step 305, a non-AP MLD associates with an AP MLD, where both devices are capable of EML operation.

At step 310, the non-AP MLD enables an enhanced multi-link multi-radio (EMLMR) mode on a plurality of links. The enabled links can be referred to as EMLMR links.

At step 315, the non-AP MLD transmits a frame to the AP MLD indicating numbers of supported spatial streams corresponding to different modulation and coding schemes for receiving data using EMLMR operation over a plurality of supported bandwidths. The frame can include an EHT-MCS and NSS set field having Rx EHT-MCS map subfields and Tx EHT-MCS map subfields that map a maximum number of spatial streams to an MCS supported for a specific bandwidth corresponding to at least one of the EMLMR links. The frame can also include capabilities (e.g., NSS and MCS) for bandwidths when EMLMR mode is not enabled according to some embodiments.

At step 320, the non-AP MLD receives a PPDU from the AP MLD over an EMLMR link using an MCS and an NSS indicated in the frame as being supported by a bandwidth of the EMLMR link, and/or transmits a PPDU from the AP MLD over the EMLRM link using an MCS and an NSS indicated in the frame as being supported by a bandwidth of the EMLMR link. The non-AP MLD can transmit and/or receive multiple PPDUs using multiple EMLMR links according to the capabilities indicated in the frame transmitted in step 315.

### Exemplary Computer Controlled System

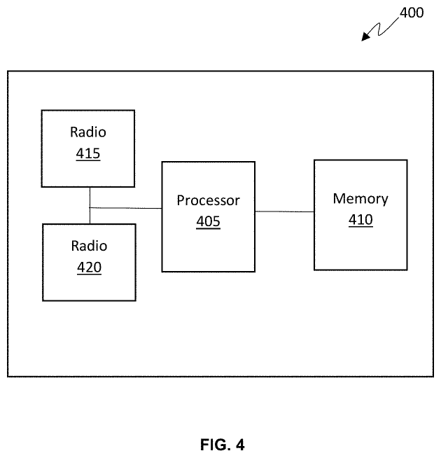

FIG. 4 depicts an exemplary wireless device 400 upon which embodiments of the present invention can be implemented. Embodiments of the present invention are drawn to multi-link wireless devices that can automatically indicate EMLMR capabilities in a novel frame exchange according to embodiments of the present invention. Wireless device 400 typically includes two or more radios for wireless communication. For example, the wireless device can indicate support for EMLMR operation including its capabilities of number of spatial streams for receiving or transmitting during EMLMR operation. Furthermore, if the set of EMLMR links have different maximum bandwidths, the MLD level capabilities are defined so that EMLMR capable devices can improve/optimize performance based on computing capabilities and RF design. The EMLMR capabilities can be indicated in an EHT-MCS And NSS set field format having Rx/Tx EHT-MCS map subfields as depicted in FIGS. 1 and 2, respectively.

Wireless device 400 includes a processor 405 for running software applications and optionally an operating system. Memory 410 can include read-only memory and/or random access memory, for example, to store applications and data (e.g., tables of index values) for use by the processor 405 and data received or transmitted by radios 415 and 420. Radios 415 and 420 can communicate with other electronic devices over a wireless network (e.g., WLAN) using multiple spatial streams (e.g., multiple antennas) and typically operates according to IEEE standards (e.g., IEEE 802.11ax, IEEE 802.11ay, IEEE 802.11be, etc.). Radios 415 and 420 can perform multi-link operations, such as multi-link EMLMR operations. Wireless device 400 can including more than two radios, according to embodiments. The radios (e.g., radios 415 and 420) can be configured to transmit and/or receive data using a number of different spatial streams based on device capabilities, for example.

Embodiments of the present invention are thus described. While the present invention has been described in particular embodiments, it should be appreciated that the present invention should not be construed as limited by such embodiments, but rather construed according to the following claims.

What is claimed is:

1. A method of wireless data reception by a non-access point (non-AP) multi-link device (MLD), the method comprising:
associating with an access point (AP) MLD;
enabling an enhanced multi-link (EML) operation mode on a plurality of EML links;
transmitting a frame to the AP MLD indicating a maximum number of supported spatial streams (NSS) corresponding to a specific modulation and coding scheme (MCS) in a physical layer protocol data unit (PPDU) using a specific supported bandwidth for receiving the PPDU using the EML operation; and
receiving the PPDU from the AP MLD over a first EML link of the plurality of EML links using a number of spatial streams that is no greater than the maximum number of supported spatial streams indicated in the frame for a combination of MCS and NSS over the first EML link using the specific supported bandwidth in the EML operation mode.

2. The method described in claim 1, wherein the maximum number of supported spatial streams using the EML operation mode is equal to or less than a total number of supported spatial streams corresponding to per-link spatial stream capabilities over the plurality of the EML links.

3. The method described in claim 1, further comprising performing an initial frame exchange with the AP MLD using per-link spatial stream capabilities over the first EML link of the plurality of EML links, wherein the receiving of the PPDU from the AP MLD over the first EML link is performed responsive to the performing an initial frame exchange.

4. The method as described in claim 1, wherein the frame comprises a modulation and coding scheme (MCS) value and a maximum number of spatial streams (NSS) field value comprising a combination of maximum numbers of supported spatial streams for different MCSs supported by the bandwidths.

5. The method as described in claim 4, wherein the MCS and NSS set field comprises a plurality of Rx EHT-MCS map subfields that map a maximum number of spatial streams to an MCS supported for a specific bandwidth corresponding to at least one of the EML links.

6. The method as described in claim 5, wherein the plurality of EML links comprises a second EML link and, wherein the first and second EML links use different plurality of Rx EHT-MCS map subfields for different bandwidths.

7. The method as described in claim 1, wherein the non-AP MLD comprises a plurality of radios operating over different frequencies for performing enhanced multi-link multi-radio (EMLMR) operations.

8. A method of transmitting wireless data by a non-access point (non-AP) multi-link device (MLD), the method comprising:
associating with an access point (AP) MLD;
enabling an enhanced multi-link (EML) mode on a plurality of EML links;
transmitting a frame to the AP MLD indicating a maximum number of supported spatial streams (NSS) corresponding to a specific modulation and coding schemes (MCS) value in a physical layer protocol data unit (PPDU) with a specific supported bandwidth for transmitting the PPDU using the EML operation; and
transmitting the physical layer protocol data unit (PPDU) to the AP MLD over a first EML link of the plurality of EML links with the number of spatial streams that is no greater than the value indicated in the frame as being supported by a combination of MCS and NSS in a bandwidth of the first EML link using the EML operation.

9. The method described in claim 8, wherein the maximum number of supported spatial streams using the EML operation mode is equal to or less than a total number of supported spatial streams corresponding to per-link capabilities over the plurality of the EML links.

10. The method described in claim 8, further comprising performing an initial frame exchange with the AP MLD over the first EML link of the plurality of EML links using an MCS and an NSS indicated in the frame as being supported by a bandwidth of the first EML link using the EML operation, and wherein the transmitting of the PPDU to the AP MLD over the first EML link is performed responsive to the performing an initial frame exchange.

11. The method as described in claim 8, wherein the frame comprises a modulation and coding scheme (MCS) and a maximum number of spatial streams (NSS) comprising a mapping of maximum numbers of supported spatial streams for different MCSs supported by different bandwidths.

12. The method as described in claim 11, wherein the MCS and NSS comprises a plurality of Tx EHT-MCS map subfields that map a maximum number of spatial streams to an MCS supported for a specific bandwidth corresponding to at least one of the EML links.

13. The method as described in claim 12, wherein the plurality of EML links comprises a second EML link, and wherein the first and second EML links use different Tx EHT-MCS map subfields for different bandwidths.

14. The method as described in claim 8, wherein the non-AP MLD comprise a plurality of radios operating over different frequencies for performing enhanced multi-link multi-radio (EMLMR) operations.

15. An apparatus for communicating wirelessly over a plurality of enhanced multi-link (EML) links, the apparatus comprising:
a processor;
a memory coupled to the processor and for storing data; and
a plurality of radios operable to perform EML operations over the plurality of EML links, and wherein the processor is operable to:
associate with an access point (AP) MLD;
enable an enhanced multi-link (EML) mode on a plurality of EML links;
transmit a frame to the AP MLD indicating a maximum numbers of supported spatial streams (NSS) corresponding to a specific modulation and coding schemes (MCS) value with a specific supported bandwidth using the EML operations;
receive a first physical layer protocol data unit (PPDU) from the AP MLD over a first EML link of the plurality of EML links with the number of spatial streams that is no greater than the value indicated in the frame as being supported by a combination of MCS and NSS in a bandwidth of the first EML link; and
transmit a second PPDU to the AP MLD over a second EML link of the plurality of EML links with the number of spatial streams that is no greater than the value indicated in the frame as being supported by a combination of MCS and NSS in a bandwidth of the second EML link.

16. The apparatus described in claim 15, wherein the processor is further operable to perform an initial frame exchange with the AP MLD using per-link spatial stream capabilities over the first EML link of the plurality of EML links, and wherein the receiving the first PPDU from the AP MLD over the first EML link is performed responsive to the initial frame exchange.

17. The apparatus described in claim 15, wherein the processor is further operable to transmit an initial frame to the AP MLD over the second EML link of the plurality of EML links using an MCS and an NSS indicated in the frame as being supported by a bandwidth of the second EML link using the EML operation, and wherein the transmitting of the PPDU to the AP MLD over the second EML link is performed responsive to the initial frame exchange.

18. The apparatus as described in claim 15, wherein the transmit a frame to the AP MLD indicating maximum numbers of supported spatial streams (NSS) corresponding to a specific modulation and coding schemes (MCS) value in a PPDU with a specific supported bandwidth using EML operations over a plurality of supported bandwidths comprises transmitting an extremely high throughput (EHT)-modulation and coding scheme (MCS) and maximum number of spatial streams (NSS) set field comprising a mapping of a maximum number of supported spatial streams for different MCSs supported by the bandwidths.

19. The apparatus as described in claim 18, wherein the EHT-MCS and NSS set field comprises a plurality of Rx EHT-MCS map subfields and Tx EHT-MCS map subfields that map a maximum number of spatial streams to an MCS that are supported for a specific bandwidth corresponding to at least one of the EML links.

20. The apparatus as described in claim 15, wherein the frame further indicates at least one of: a maximum number of sounding dimensions for performing a sounding procedure over a specific EML link using the EML operation; a beamformee spatial stream indicating the maximum number of spatial streams that can be received in an extremely high throughput (EHT) sounding null data packet (NDP) over a specific EML link using the EML operation; and a maximum dimension of compressed beamforming over a specific EML link using the EML operation.
